(19) United States
(12) Patent Application Publication
(10) Pub. No.: US 2013/0308337 A1
(43) Pub. Date: Nov. 21, 2013

(54) BACKLIGHT MODULE

(71) Applicant: AU OPTRONICS CORP., Hsin-Chu (TW)

(72) Inventors: Yi-Wen Chang, Hsin-Chu (TW); Fu-Cheng Fan, Hsin-Chu (TW)

(73) Assignee: AU OPTRONICS CORP., Hsin-Chu (TW)

(21) Appl. No.: 13/665,943

(22) Filed: Nov. 1, 2012

(30) Foreign Application Priority Data
May 16, 2012 (TW) 101117348

(51) Int. Cl. F21V 9/00; F21V 13/02

(52) U.S. Cl. 362/606; 362/611

(57) ABSTRACT

A backlight module includes a light source, a photoluminescence layer, and an optical film. The light source is used to provide a light beam. The photoluminescence layer is excited by the light beam from the light source and generates an excitation light. The optical film overlaps the photoluminescence layer along a vertical projective direction. The optical film includes a substrate and a plurality of two-dimensional symmetrical micro-structures. The two-dimensional symmetrical micro-structures are disposed on at least one surface of the substrate. The excitation light is emitted through the two-dimensional symmetrical micro-structures.

### BACKGROUND

1. Technical Field

The present disclosure generally relates to the field of backlight modules, and more particularly, to a backlight module having a photoluminescence layer to emit light, which can improve the light distribution uniformity by the use of an optical film.

2. Description of the Prior Art

Owing to their superior performances, like low power consumption, long operation lifetime, reduced driving voltage and quick switching rate, light-emitting diodes (LEDs), with these outstanding properties, are very useful for applications as diverse as: replacements for indoor lighting and in traffic signals. Additionally, LEDs are also integrated into backlight modules to therefore become a part of flat panel displays.

Please refer to FIGS. 1 and 2, which respectively show conventional backlight modules 101 and 102. As shown in FIG. 1, the backlight module 101 in the prior art includes a light source 110, a light guide plate 120, a diffusion plate 130 and a brightness enhancement film 140. The backlight module 101 shown here belongs to an edge-lit backlight module, wherein the light source 110 is disposed at one side of the light guide plate 120. The light source 110 may include LEDs or other suitable light source structures in order to generate a light beam L1. The light beam L1 may be guided toward a vertical projective direction Z. A transmitting direction of the light beam L1 can be further altered by the diffusion plate 130 so that the light beam L1 can be distributed along a specific direction. The brightness enhancement film 140 is used to further enhance brightness of the light beam L1 along the vertical projective direction Z (also-called a direct viewing direction). Generally, the brightness enhancement film 140 is a cross bright enhancement film (cross BEF), which includes two prism plates. Each of the prism plate includes a plurality of stripe grooves arrayed in parallel and can be interlaced with the other prism plate in order to obtain improved enhancement in brightness. However, most of the backlight sources applied in conventional flat panels are white light sources and it is known that white LEDs still have many unsolved drawbacks, like low color purity, complexity in structure, relatively high manufacturing costs and so forth. In order to improve these drawbacks, a backlight module 102 shown in FIG. 2 is also provided. The working principle of the backlight module 102 includes steps like: first, a light source 111 is used to generate a light beam L2 which may then be transmitted to a photoluminescence layer 150 through a light guide plate 120; and the photoluminescence layer 150 is excited by the light beam L2 which then generates an excitation light L3. In the structure of the backlight module 102, the light source 111 may be chosen from a blue LED so that the blue light beam L2 can excite the photoluminescence layer 150 and generate the white excitation light L3. In this way, the structure of the light source can be simplified. However, the excitation light L3 generated by the photoluminescence layer 150 is a non-directional light beam. That is to say, in most cases, the brightness of the excitation light L3 along the vertical projective direction Z is substantially identical to that along a side viewing direction S. Therefore, after the excitation light L3 is transmitted through the conventional brightness enhancement film 140, the excitation light L3 along the vertical projective direction Z is less bright than the excitation light L3 along the side viewing direction S, which reduces the performance of the backlight module in a normal direct viewing direction. That is to say, it is not suitable to apply the excitation light L3 emitted from the photoluminescence layer 150 in a backlight module having a conventional brightness enhancement film.

### SUMMARY

The objective of the disclosure is to provide a backlight module which has a better brightness and light distribution uniformity through utilizing an optical film with two-dimensional symmetrical micro-structures and a photoluminescence layer

According to one embodiment of the present invention, a backlight module is provided. The backlight module includes a light source, a photoluminescence layer and an optical film. The light source is used to provide a light beam. The photoluminescence layer is excited by the light beam from the light source and generates an excitation light. The optical film overlaps the photoluminescence layer along a vertical projective direction. The optical film includes a substrate and a plurality of two-dimensional symmetrical micro-structures. The two-dimensional symmetrical micro-structures are disposed on at least one surface of the substrate and the excitation light is emitted through the two-dimensional symmetrical micro-structures.

According to another embodiment of the present invention, a backlight module is provided, which includes the following components. A light source which is used to provide light beam, and a photoluminescence layer which is excited by the light beam from the light source and can generate excitation light, wherein the excitation light along a vertical projective direction has a brightness that is substantially the same as that of the excitation light along a side viewing direction. And an optical film is stacked with the photoluminescence layer along the vertical projective direction, wherein the optical film includes a substrate and a plurality of two-dimensional symmetrical micro-structures, the two-dimensional symmetrical micro-structures are disposed on at least one surface of the substrate, and the excitation light is emitted through the two-dimensional symmetrical micro-structures. The function of the two-dimensional symmetrical micro-structures is to have the excitation light along the vertical projective direction be substantially brighter than the excitation light along a side viewing direction after the excitation light is emitted through the two-dimensional symmetrical micro-structures.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a backlight module in the prior art.

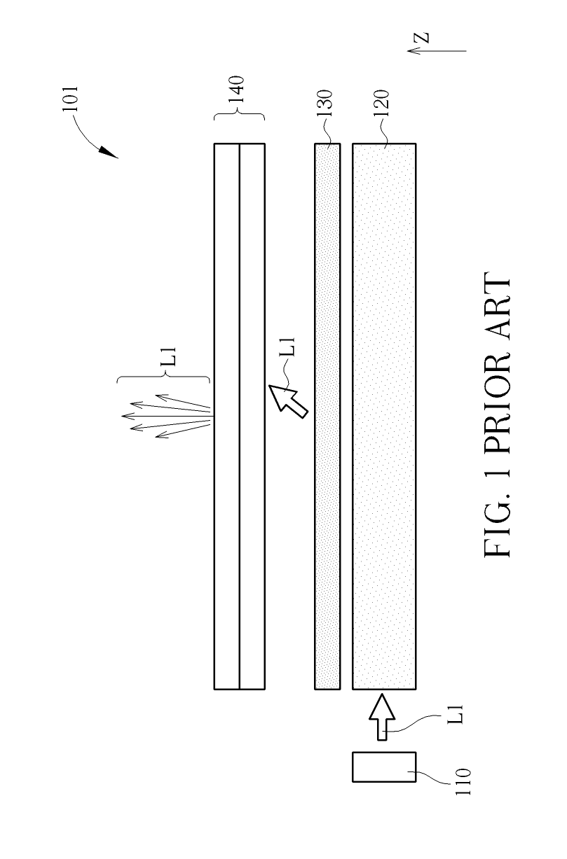

FIG. 2 is a schematic diagram showing a backlight modules in the prior art.

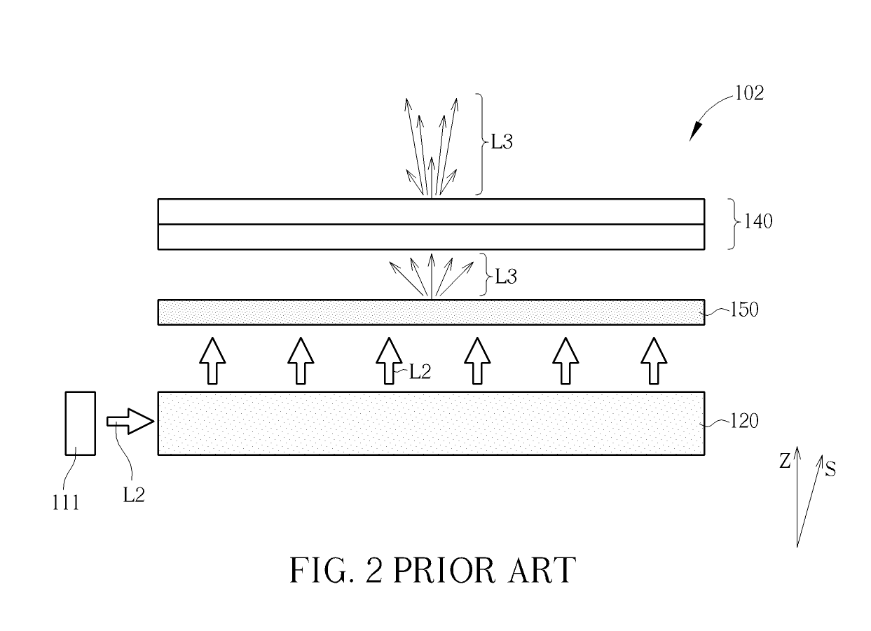

FIG. 3 is a cross-sectional diagram of a backlight module according to the first embodiment of the present invention.

FIG. 4 is a partially enlarged diagram showing an optical film in the backlight module according to the first embodiment of the present invention.

FIG. 5 is a top-view diagram showing an optical film in the backlight module according to the first embodiment of the present invention.

FIG. 6 is a top-view diagram showing an optical film in the backlight module according to the first embodiment of the present invention.

FIG. 7 is a schematic diagram showing a backlight module according to the second embodiment of the present invention.

FIG. 8 is a schematic diagram showing a backlight module according to the third embodiment of the present invention.

FIG. 9 is a schematic diagram showing a backlight module according to the fourth embodiment of the present invention.

FIG. 10 is a schematic diagram showing a backlight module according to the fifth embodiment of the present invention.

FIG. 11 is a schematic diagram showing a backlight module according to the sixth embodiment of the present invention.

FIG. 12 is a schematic diagram showing a backlight module according to the seventh embodiment of the present invention.

FIG. 13 is a schematic diagram showing a backlight module according to the eighth embodiment of the present invention.

FIG. 14 is a top-view diagram showing an optical film in the backlight module according to the eight embodiment of the present invention.

### DETAILED DESCRIPTION

In the following description, numerous specific details are given to provide a thorough understanding of a backlight module related to the invention. In addition, reference is made to the accompanying drawings, which form a part hereof, and in which is shown by way of illustration specific examples in which the embodiments may be practiced.

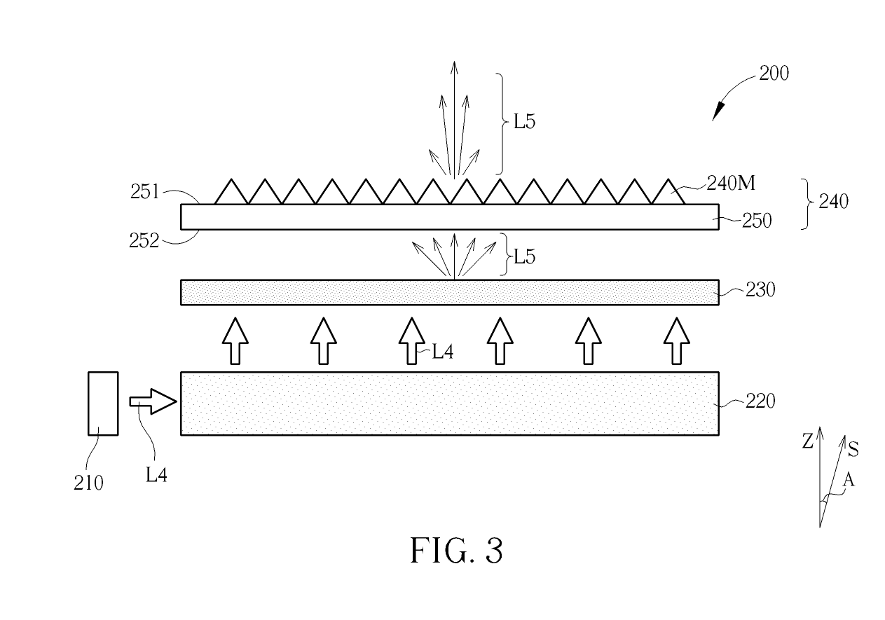

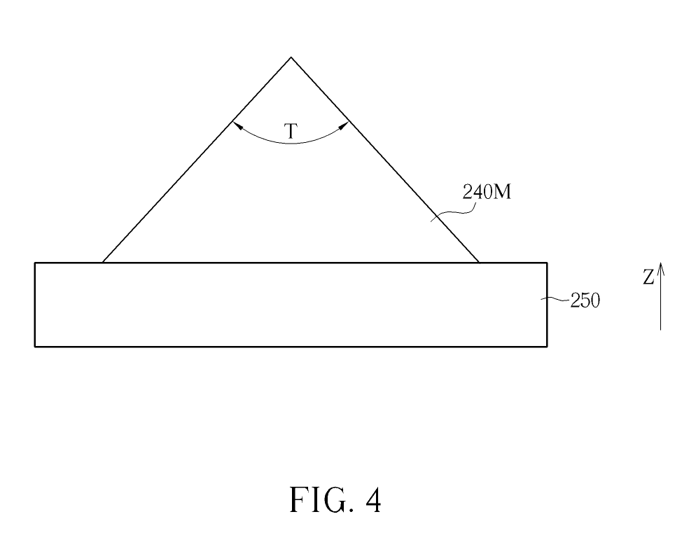

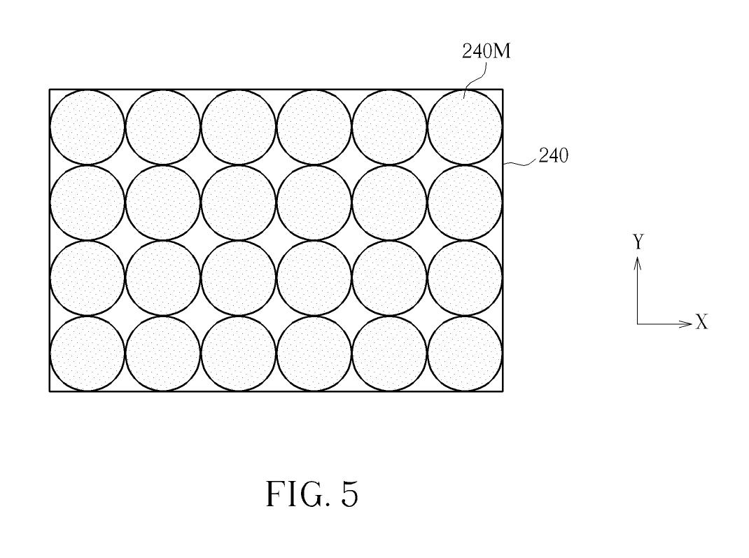

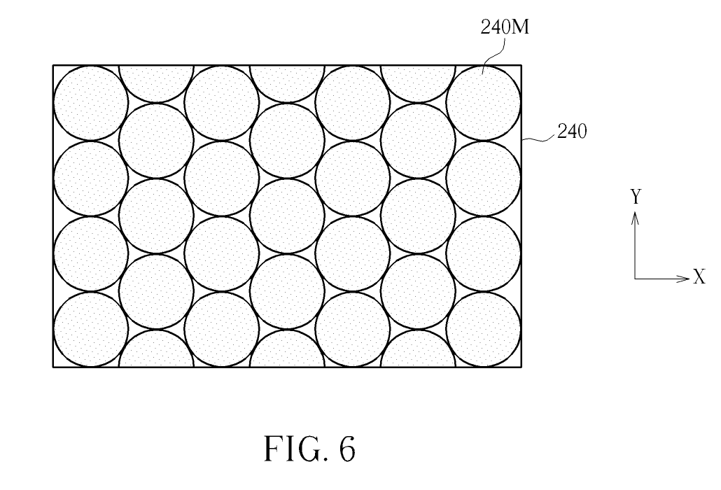

Please refer to FIGS. 3 to 6. FIGS. 3 to 6 are schematic diagrams showing a backlight module according to the first embodiment of the present invention, wherein FIG. 3 is a cross-sectional diagram; FIG. 4 is a partially enlarged diagram showing an optical film in the backlight module; FIGS. 5 to 6 are top-view diagrams respectively showing an optical film in the backlight module. It should be noted that the drawings showing the embodiments of the apparatus are not to scale and some dimensions are exaggerated for clarity of presentation, the relative proportion may be properly adjusted in order to fulfill various design needs. As shown in FIGS. 3 and 4. The embodiment provides a backlight module 200 which includes a light source 210, a light guide plate 220, a photoluminescence layer 230 and an optical film 240. The light source 210 is used to provide a light beam L4, which preferably includes a blue ray light source, like blue ray LED light source for example, or an ultraviolet light source, but is not limited thereto. The light guide plate 220 is disposed correspondingly to the photoluminescence layer 230 and the light source 210 is disposed on one side of the light guide plate 220. The main purpose of the light guide plate 220 is to alter a transmitting direction of the light beam L4 generating from the light source 210 so that the light beam L4 may be transmitted along a vertical projective direction Z afterward. In this embodiment, the light guide plate 220, the photoluminescence layer 230 and the optical film 240 are stacked upwardly along the vertical projective direction Z in that order. That is to say, the light guide plate 220, the photoluminescence layer 230 and the optical film 240 mutually overlap each other along the vertical projective direction Z. In contrast, the light source 210 located on the side of the light guide plate 220 does not overlap the light guide plate 220, the photoluminescence layer 230 and the optical film 240 along the vertical projective direction Z. Therefore, the backlight module 200 described in this embodiment can be regarded as a kind of edge-lit backlight module, but is not limited thereto. The photoluminescence layer 230 is excited by the light beam L4 from the light source 210 and therefore radiates an excitation light L5. The composition of the photoluminescence layer 230 may include fluorescent material or phosphorescent material, but is not limited thereto. For example, the photoluminescence layer 230 may comprise yttrium aluminum garnet (YAG) material, red and green material, quantum dot (QD) material or other suitable photoluminescent material. For a specific example, when the light beam L4 generated from the light source 210 is a blue ray or an ultraviolet ray, it may stimulate the photoluminescence layer 230 including at least one of the above materials to emit an excitation beam with specific colors. As a result, the photoluminescence layer 230 can show a white color excitation light L5 afterward. It is worth noting that both the light source and the photoluminescence layer may be replaced with other suitable light source and photoluminescence layer in order to obtain the required excitation light. Additionally, the optical film 240 includes a substrate 250 and a plurality of two-dimensional symmetrical micro-structures 240M. The substrate 250 has an upper surface 251 and a lower surface 252, wherein the lower surface 252 faces the photoluminescence layer 230 and the upper surface 251 is back against the photoluminescence layer 230. The two-dimensional symmetrical micro-structures 240M are disposed on the upper surface 251 of the substrate 250 and the excitation light L5 can be emitted through the two-dimensional symmetrical micro-structures 240M. It is worth noting that, the two-dimensional symmetrical micro-structures 240M in this embodiment are convex micro-structures, and more specifically, they are convex micro-structures with cone shapes and each of which has an apex T ranging from 30 degrees to 130 degrees in order to achieve a better optical performance. The two-dimensional symmetrical micro-structures in the embodiment of the present invention, however, may also be replaced by other kinds of suitable two-dimensional symmetrical micro-structures, if required. It should be noted that each two orthogonal axes on the surface of the substrate may be regarded as reference axes, and the two-dimensional symmetric micro-structures must be symmetry based on these two reference axes. Additionally, the two-dimensional symmetric micro-structures include several three-dimensional structures and each of the three-dimensional structures has a two-dimensional symmetric characteristic. For example, the two-dimensional symmetric structures may be structures with hemisphere shapes, cone shapes, pyramid shapes and so forth.

It is worth noting that, owing to the inherent illuminating property of the photoluminescence layer 230, the excitation light L5 resulting from the photoluminescence layer 230 is a non-directional light beam. That is to say, before the excitation light L5 reaches and transmits through the two-dimensional symmetric micro-structures 240M, the brightness of the excitation light L5 along the vertical projective direction Z is substantially the same as that along a side viewing direction S. There is an angle A between the side viewing direction S and the vertical projective direction Z, which approximately ranges from 0 degree to ±90 degrees. For example, when the vertical projective direction Z is used as a reference vector, an angle A along a clockwise direction is defined as a positive angle, and an angle A along a counter-clockwise direction is otherwise defined as a negative angle. After the excitation light L5 is emitted through the two-dimensional symmetrical micro-structures 240M, the excitation light L5 along the vertical projective direction Z can become substantially brighter than the excitation light L5 along the side viewing direction S owing to the influence of the two-dimensional symmetrical micro-structures 240M. In this embodiment, when the angle A ranges from 0 degree to ±15 degrees, a brightness ratio of the excitation light L5 along the vertical projective direction Z to the excitation light L5 along the side viewing direction S ranges from 1 to 2. The brightness ratio in each direction may be adjusted properly by varying an angle of each apex T in the two-dimensional symmetric micro-structures 240M. For example, when the two-dimensional symmetric micro-structures 240M have cone shapes, the ratio of the brightness along the vertical projective direction Z to the brightness along the side viewing direction S with the angle A in ±15° is equal to 2. As the angle of each apex T is increased, the ratio of the brightness along the vertical projective direction Z to the brightness along the side viewing direction S with the angle A in ±45° is equal to 2, that is, the brightness along the side viewing direction S is correspondingly enhanced as the angle of the apex T is increased. For example, after the excitation light L5 is transmitted through the two-dimensional symmetrical micro-structures 240M, the whole brightness along the direct view direction may be raised by approximately 90% (the brightness is increased from 280 W to 531 W), and the radiant intensity (W/sr) along the direct view direction may rise by nearly 60% concurrently (the radiant intensity is increased from 225 W/sr to 360 W/sr). When the angle A between the side viewing direction S and the vertical projective direction Z is approximately 20°, the brightness of the excitation light L5 along the vertical projective direction Z may be raised, which may be 3 times brighter than that along the side viewing direction S. Furthermore, since the two-dimensional symmetrical micro-structures 240M in this embodiment use the vertical projective direction Z as a symmetric axis that is perpendicular to the backlight module 200, a relatively uniform optical distribution in every viewing angle is obtained and the two-dimensional symmetrical micro-structures 240M are suitable for the excitation light L5. Besides, since the mutually stacked prism plates used in the prior art are replaced by the two-dimensional symmetrical micro-structures 240M in the present invention, an entire thickness of the backlight module 200 may be reduced correspondingly. In addition, the back light module 200 disclosed in this embodiment includes a certain gap (also called air gap) or an adhesive layer (not shown) between the photoluminescence layer 230 and the substrate 250. By using the gap or choosing the adhesive layer with a proper refractive index, the total reflection of the excitation light L5 with a certain incident angle may not take place on the interface between the photoluminescence layer 230 and the substrate 250. As a result, the whole illuminating quality can be improved. In this embodiment, the two-dimensional symmetrical micro-structures 240M can achieve the best optical brightness when they are all in cone shapes.

Additionally, as shown in FIGS. 5 and 6, the arrangement of the two-dimensional symmetrical micro-structures 240M may include an array arrangement (as shown in FIG. 5), an hexagonal closed-pack (hcp) arrangement (as shown in FIG. 6) or other suitable regular or irregular arrangements. For the sake of clarity, two-dimensional symmetrical micro-structures 240M with cone-shaped structures are shown in this embodiment, which is not limited thereto. The array arrangement has advantages such as easy manufacturing in a simple way, while the hcp arrangement achieves better performances in brightness enhancement. However, the arrangement of the two-dimensional symmetrical micro-structures 240M is not limited to the above-mentioned two types, and it can be further modified according to different optical design needs. For example, an hcp arrangement is distributed in certain regions, and a random arrangement distributes between certain regions (having hcp arrangement). Each of the two-dimensional symmetrical micro-structures 240M preferably have a size ranging from 0.01 mm to 0.1 mm, but is not limited thereto.

In the following paragraph, various embodiments about backlight modules are disclosed and the description below is mainly focused on differences among each embodiment. In addition, like or similar features will usually be described with same reference numerals for ease of illustration and description thereof.

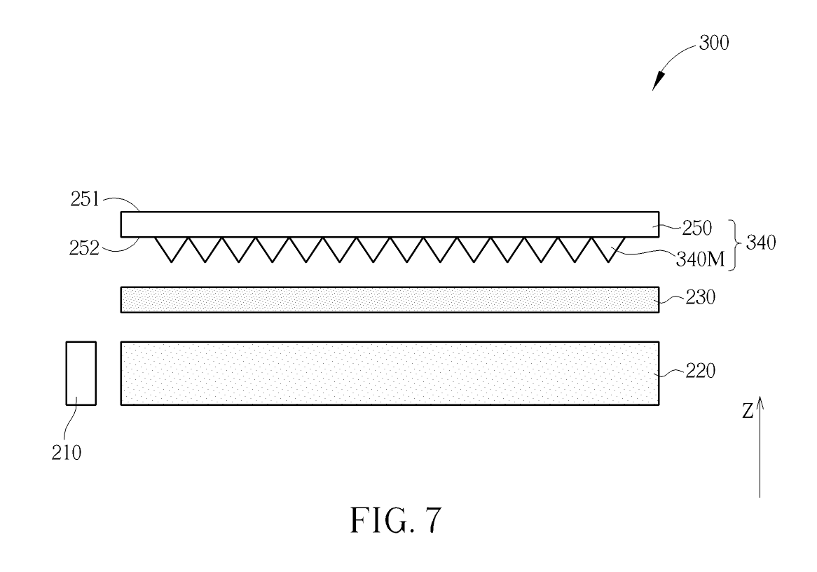

Please refer to FIG. 7. FIG. 7 is a schematic diagram showing a backlight module 300 according to the second embodiment of the invention. As shown in FIG. 7, the backlight module 300 includes a light source 210, a light guide plate 220, a photoluminescence layer 230 and an optical film 340. One difference between the backlight module 300 disclosed in this embodiment and the backlight module 200 disclosed in the previous first embodiments is that, the optical film 340 in this embodiment includes a substrate 250 and a plurality of two-dimensional symmetrical micro-structures 340M. And the two-dimensional symmetrical micro-structures 340M are disposed on the lower surface 252 of the substrate 250 instead of on the upper surface 251 of the substrate 250. When the two-dimensional symmetrical micro-structures 340M are disposed on the lower surface 252 of the substrate 250, drawbacks, such as distinguishability, resulting from the shape of the two-dimensional symmetrical micro-structures 340M may be overcome. Comparatively, films under the optical film may not be scratched when the two-dimensional symmetric structures are disposed on the upper surface 251 of the substrate 250. Apart from the position of the two-dimensional symmetrical micro-structures 340M, the rest of the parts of the backlight module 300 disclosed in this embodiment, such as positions of other parts, material properties, optical properties and means of radiation are almost similar to those shown in the backlight module 200 according to the previous first preferred embodiment. For the sake of brevity, these similar configurations and properties are therefore not disclosed in detail.

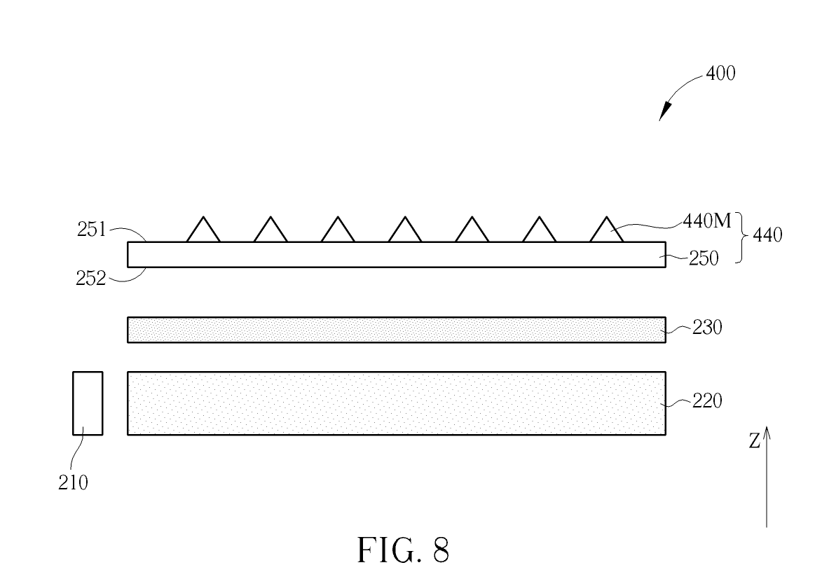

Please refer to FIG. 8. FIG. 8 is a schematic diagram showing a backlight module 400 according to the third embodiment of the present invention. As shown in FIG. 8, the backlight module 400 includes a light source 210, a light guide plate 220, a photoluminescence layer 230 and an optical film 440. One difference between the backlight module 400 disclosed in this embodiment and the backlight module 200 disclosed in the first embodiment is that the optical film 440 in this embodiment includes a substrate 250 and a plurality of two-dimensional symmetrical micro-structures 440M. There also are spaces between adjacent two-dimensional symmetrical micro-structures 440M. That is to say, the two-dimensional symmetrical micro-structures 440M are not closely packed with one another. As a result, the difficulty for manufacturing the optical film 440 is reduced and the corresponding yield can be increased effectively. Apart from the position of the two-dimensional symmetrical micro-structures 440M, the rest of the parts of the backlight module 400 disclosed in this embodiment, such as positions of other parts, material properties, optical properties and means of radiation are almost similar to those shown in the backlight module 200 according to the first preferred embodiment. For the sake of brevity, these similar configurations and properties are therefore not disclosed in detail.

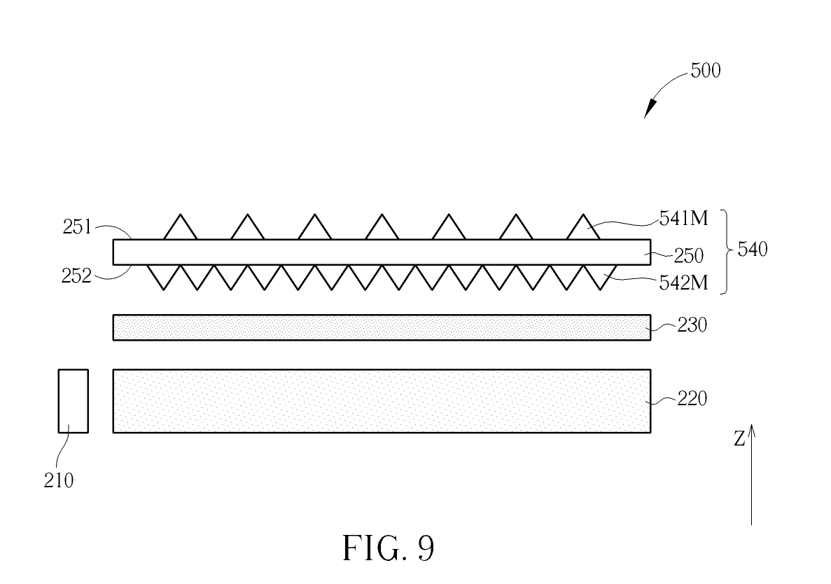

Please refer to FIG. 9. FIG. 9 is a schematic diagram showing a backlight module 500 according to the fourth embodiment of the present invention. As shown in FIG. 9, the backlight module 500 includes a light source 210, a light guide plate 220, a photoluminescence layer 230 and an optical film 540. One difference between the backlight module 500 disclosed in this embodiment and the backlight module 200 disclosed in the previous first embodiments is that, the optical film 540 in this embodiment includes a substrate 250, a plurality of two-dimensional symmetrical micro-structures 541M and a plurality of two-dimensional symmetrical micro-structures 542M. Each of the two-dimensional symmetrical micro-structures 541M is disposed on the upper surface 251 of the substrate 250 and each of the two-dimensional symmetrical micro-structures 542M is disposed on the lower surface 252 of the substrate 250. In other words, both of the surfaces of the substrate 250 disclosed in this embodiment have two-dimensional symmetrical micro-structures, so that a required optical performance can be further enhanced. Apart from those two-dimensional symmetrical micro-structures 541M and two-dimensional symmetrical micro-structures 542M disposed respectively on the upper surface 251 and the lower surface 252 of the substrate 250, the backlight module 500 disclosed in this embodiment, has a configuration and properties, such as positions of other parts, material properties, optical properties and means of radiation similar to those shown in the backlight module 200 according to the first preferred embodiment. For the sake of brevity, these similar configurations and properties are therefore not disclosed in detail.

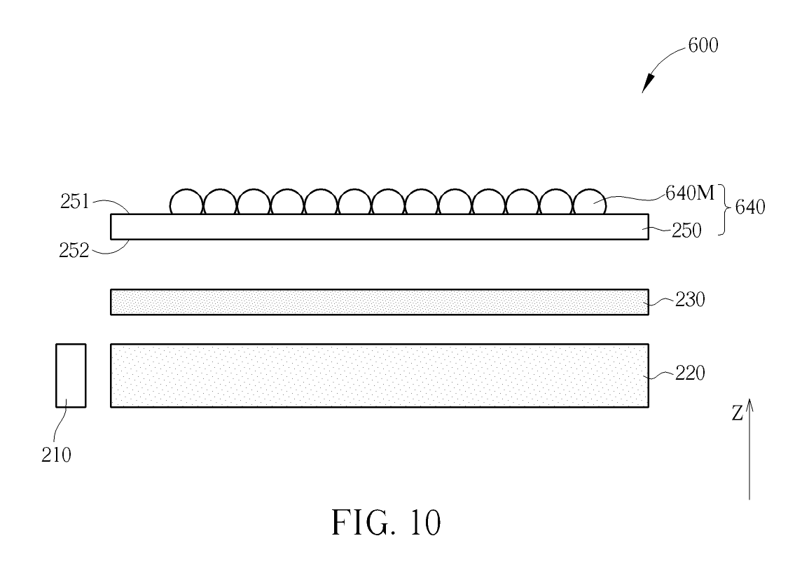

Please refer to FIG. 10. FIG. 10 is a schematic diagram showing a backlight module 600 according to the fifth embodiment of the present invention. As shown in FIG. 10, the backlight module 600 includes a light source 210, a light guide plate 220, a photoluminescence layer 230 and an optical film 640. One difference between the backlight module 600 disclosed in this embodiment and the backlight module 200 disclosed in the first embodiment is that the optical film 640 in this embodiment includes a substrate 250 and a plurality of two-dimensional symmetrical micro-structures 640M. Each of the two-dimensional symmetrical micro-structures 640M also has a spherical micro-structure, which can protect overlaying films or itself from scratching. Apart from the shape of the two-dimensional symmetrical micro-structures 640M, the rest of the parts of the backlight module 600 disclosed in this embodiment, such as positions of other parts, material properties, optical properties and means of radiation are almost similar to those shown in the backlight module 200 according to the first preferred embodiment. For the sake of brevity, these similar configurations and properties are therefore not disclosed in detail.

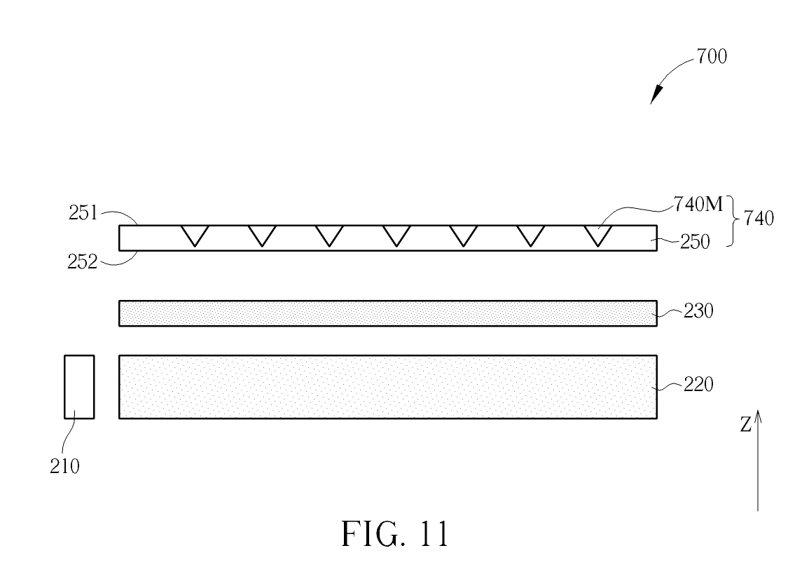

Please refer to FIG. 11. FIG. 11 is a schematic diagram showing a backlight module 700 according to the sixth embodiment of the invention. As shown in FIG. 11, the backlight module 700 includes a light source 210, a light guide plate 220, a photoluminescence layer 230 and an optical film 740. One difference between the backlight module 700 disclosed in this embodiment and the backlight module 200 disclosed in the first embodiments is that the optical film 740 in this embodiment includes a substrate 250 and a plurality of two-dimensional symmetrical micro-structures 740M. Each of the two-dimensional symmetrical micro-structures 740M is a concave micro-structure, which can further reduce the entire thickness of the optical film 740. Apart from the shape of the two-dimensional symmetrical micro-structures 740M, the rest parts of the backlight module 700 disclosed in this embodiment, such as positions of other parts, material properties, optical properties and means of radiation are almost similar to those shown in the backlight module 200 according to the first preferred embodiment. For the sake of brevity, these similar configurations and properties are therefore not disclosed in detail.

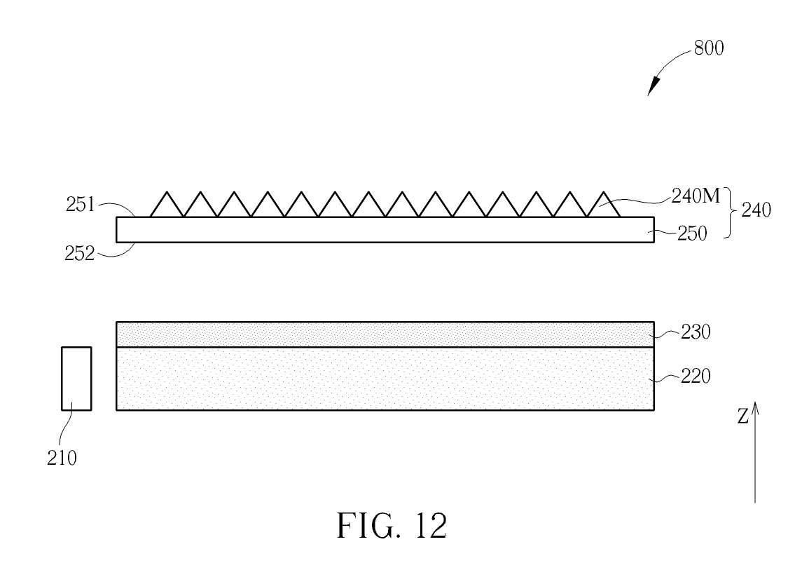

Please refer to FIG. 12. FIG. 12 is a schematic diagram showing a backlight module 800 according to the seventh embodiment of the present invention. As shown in FIG. 11, one difference between the backlight module 800 disclosed in this embodiment and the backlight module 200 disclosed in the first embodiments is that, the photoluminescence layer 230 is directly formed on the light guide plate 220. In this way, the fabrication steps corresponding to the photoluminescence layer 230 and the light guide plate 220 may be integrated so that the overall fabrication processes can be simplified. Additionally, since the photoluminescence layer 230 and the light guide plate 220 are firmly disposed, the light beam can transmit through the layer and the plate successfully without unnecessary reflection on interfaces of other materials. As a result, the intensity loss of the light beam may be reduced. Apart from a way of positioning of the photoluminescence layer 230 and the light guide plate 220, the rest of the parts of the backlight module 800 disclosed in this embodiment, such as positions of other parts, material properties, optical properties and means of radiation are almost similar to those shown in the backlight module 200 according to the first preferred embodiment. For the sake of brevity, these similar configurations and properties are therefore not disclosed in detail.

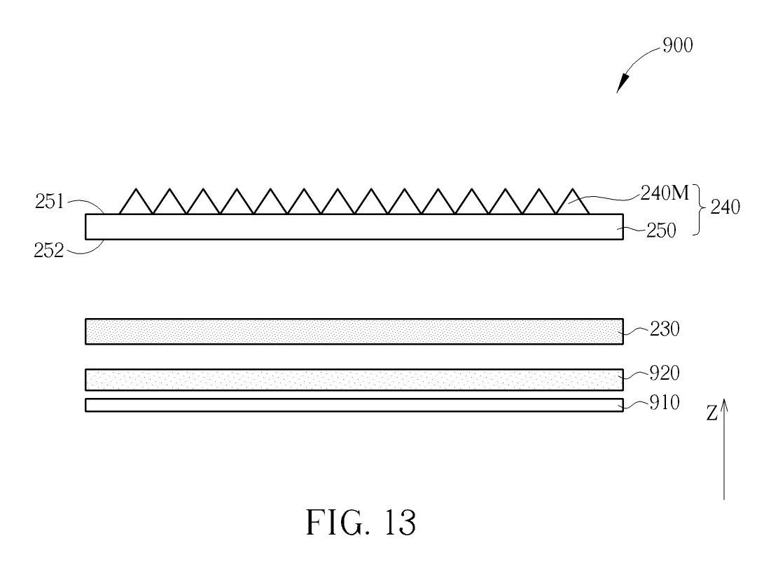

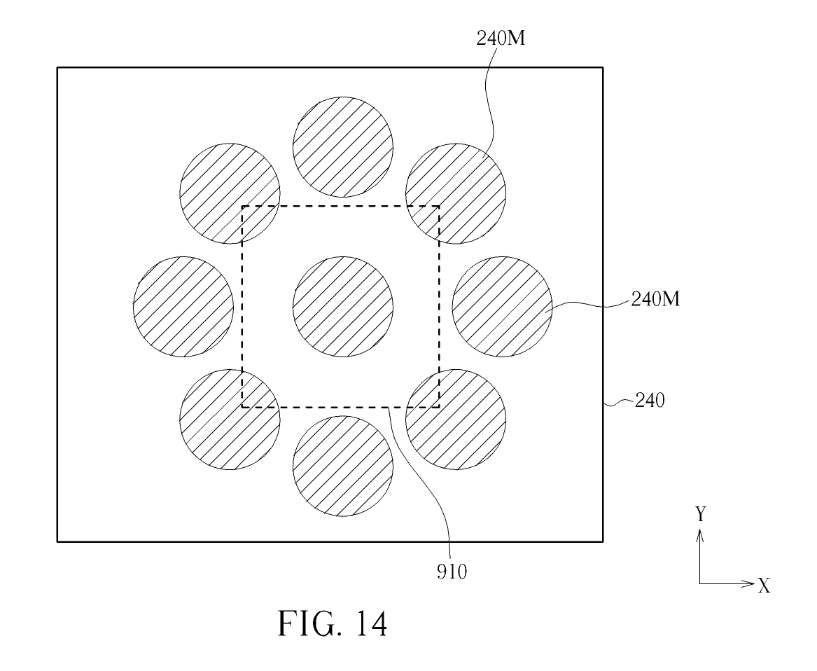

Please refer to FIGS. 13 and 14. FIGS. 13 and 14 are schematic diagrams showing a backlight module 900 according to the eighth embodiment of the invention, wherein FIG. 14 is a top-view showing an optical film in a backlight module. As shown in FIG. 13, the backlight module 900 includes a light source 910, an optical plate 920, a photoluminescence layer 230 and an optical film 240. One difference between the backlight module 900 disclosed in this embodiment and the backlight module 200 disclosed in the first embodiments is that the light source 910, the photoluminescence layer 230 and the optical film 240 are stacked upwardly along the vertical projective direction Z in that order. That is to say, the backlight module 900 disclosed in this embodiment can be a direct type backlight module, but is not limited thereto. Additionally, the optical plate 920 is disposed between the light source 910 and the photoluminescence layer 230. The optical plate 920 may have specific optical properties, like light guiding and/or diffusion properties, if required. Apart from a way of positioning of the light source 910 and the optical plate 920, the rest of the parts of the backlight module 900 disclosed in this embodiment, such as positions of other parts, material properties, optical properties and means of radiation are almost similar to those shown in the backlight module 200 according to the first preferred embodiment. For the sake of brevity, these similar configurations and properties are therefore not disclosed in detail. It is worth noting that, in order to obtain the required optical properties, the direct type backlight module 910 disclosed in this embodiment may be integrated with the optical film described in the second to seventh preferred embodiment. Similarly, the two-dimensional symmetrical micro-structures 240M in this embodiment may include an array arrangement (as shown in FIG. 5) and an hcp arrangement (as shown in FIG. 6). Furthermore, they may be arranged in a structure as shown in FIG. 14. That is to say, each light source 910 may act as a center of a circle so that two-dimensional symmetrical structures 240M may be arranged around each of the light sources 910 and show a circular arrangement. Additionally, there may be a plurality of light sources 910 in other embodiments of the present invention so that other two-dimensional symmetrical micro-structures 240M with various arrangements may be interposed between each set including the light source 910 and the corresponding two-dimensional symmetrical micro-structures 240M circling around the light source 910.

To summarize, a backlight module disclosed in the present invention has an optical film with two-dimensional symmetrical micro-structures and a photoluminescence layer. The photoluminescence layer can be exited by a light beam from a light source and then emits excitation light. The excitation light is able to be transmitted through the two-dimensional symmetrical micro-structures afterward. As a result, the whole brightness and the distribution of the brightness are improved effectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A backlight module, comprising:
a light source, used to provide a light beam;
a photoluminescence layer, excited by the light beam from the light source and generating an excitation light; and
an optical film, stacked with the photoluminescence layer along a vertical projective direction, wherein the optical film comprises a substrate and a plurality of two-dimensional symmetrical micro-structures, the two-dimensional symmetrical micro-structures are disposed on at least one surface of the substrate, and the excitation light is emitted through the two-dimensional symmetrical micro-structures.

2. The backlight module according to claim 1, wherein each of the two-dimensional symmetrical micro-structures comprises a spherical micro-structure or a cone-shaped micro-structure.

3. The backlight module according to claim 2, wherein the cone-shaped structure has an apex with an angle ranging from 30 degrees to 130 degrees.

4. The backlight module according to claim 1, wherein each of the two-dimensional symmetrical micro-structures comprises a convex micro-structure or a concave micro-structure.

5. The backlight module according to claim 1, further comprising a light guide plate disposed corresponding to the photoluminescence layer, wherein the light source is disposed on at least one side of the light guide plate, and the light guide plate, the photoluminescence layer and the optical film are stacked upwardly along the vertical projective direction in sequence.

6. The backlight module according to claim 1, wherein the light source, the photoluminescence layer and the optical film are stacked upwardly along the vertical projective direction in sequence.

7. The backlight module according to claim 1, wherein the excitation light along the vertical projective direction has a brightness substantially similar to that of the excitation light along a side viewing direction, and the excitation light along the vertical projective direction is substantially brighter than the excitation light along the side viewing direction after the excitation light is emitted through the two-dimensional symmetrical micro-structures.

8. The backlight module according to claim 7, wherein an angle between the side viewing direction and the vertical projective direction ranges from 0 degree to ±90 degrees.

9. A backlight module, comprising:
a light source, used to provide a light beam;
a photoluminescence layer, excited by the light beam from the light source and generating an excitation light, wherein the excitation light along a vertical projective direction has a brightness substantially similar to that of the excitation light along a side viewing direction; and
an optical film stacked with the photoluminescence layer along the vertical projective direction, wherein the optical film comprises a substrate and a plurality of two-dimensional symmetrical micro-structures, the two-dimensional symmetrical micro-structures are disposed on at least one surface of the substrate, and the excitation light is emitted through the two-dimensional symmetrical micro-structures,
wherein the two-dimensional symmetrical micro-structures are used to have the excitation light along the vertical projective direction to be substantially brighter than the excitation light along the side viewing direction after the excitation light is emitted through the two-dimensional symmetrical micro-structures.

10. The backlight module according to claim 9, wherein an angle between the side viewing direction and the vertical projective direction ranges from 0 degree to ±90 degrees.
